(19) United States
(12) Patent Application Publication
(10) Pub. No.: US 2015/0281176 A1
(43) Pub. Date: Oct. 1, 2015

(54) Method And Technique for Automated Collection, Analysis, and Distribution of Network Security Threat Information

(71) Applicant: Bret Banfield, Santa Clara, CA (US)

(72) Inventor: Bret Banfield, Santa Clara, CA (US)

(21) Appl. No.: 14/242,768

(22) Filed: Apr. 1, 2014

(51) Int. Cl. H04L 29/06

(52) U.S. Cl. CPC H04L 63/02

(57) ABSTRACT

A Method and Technique for Automated Collection, Analysis, and Distribution of Network Security Threat Information. A new and modern threat distribution system be able to update a large number of distributed firewall devices with threat information without impacting performance. The network of firewall devices collects analysis data from all firewall devices in the network, and transmits it to a central server system. The central server system will continually distribute new threat and update information to the networked firewall devices. This feedback and update operation within the network is automated in order to result in drastic improvements in the performance, scalability and security of a modern network infrastructure.

This application is filed within one year of, and claims priority to Provisional Application Ser. No. 61/808,600, filed Apr. 4, 2013.

### BACKGROUND OF THE INVENTION

1. Field of the Invention

This invention relates specifically to a Method and Technique for Automated Collection, Analysis, and Distribution of Network Security Threat Information.

2. Description of Related Art

Today's firewall network devices are standalone, and their intrusion detection systems can only be updated manually. They analyze both incoming and outgoing network packets and allow or disallow further transmission based on a set of rules. These rule sets must be supplied manually by the user into the firewall. Some devices permit the use of a software scripting language to facilitate the loading of rules into the device. The devices that do not have a scripting language interface require manual input of the rule sets. Rule set authorship is accomplished by a network administrator who has direct access to the device, or by an external organization who then distributes the set via the internet (i.e. via electronic mail, ftp, or other internet protocol). All of these current approaches involve a significant amount of user interaction for information collection, threat assessment and analysis, and rule programming, and are really only adequate for small threat volumes and infrequent updates. However, they do not scale-up well as the volume of threats and frequency of required updates increase. Furthermore, they do not allow for a holistic view of the entire network, since there is no mechanism for multi box coordination.

What is needed is a Method for collecting, analyzing, and redistributing threat data that can: (1) uniquely handle large amounts of threat data without negatively impacting system performance; (2) require no human interaction (i.e. be automatic); (3) allow for automatic closed loop control over threat updates; and (4) provide an ability to control multiple devices automatically and simultaneously allowing Wide Area Network level coordination and feedback.

### SUMMARY OF THE INVENTION

In light of the aforementioned problems associated with the prior devices and systems, it is an object of the present invention to provide a Method and Technique for Automated Collection, Analysis, and Distribution of Network Security Threat Information. A new and modern threat distribution system should be able to update a large number of distributed firewalls with threat information (while not impacting performance), collect analysis data from the same devices, provide a WAN-level closed loop control, and be automatic in nature so as not to have any human intervention necessary at each network site. The implementation of the system should automatically update and collect data from distributed network firewall devices, thereby resulting in drastic improvements in the scalability and security of a modern network infrastructure.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a network diagram with an preferred embodiment of one of the firewall device of the present invention installed therein; and

FIG. 2 is a block diagram of the major computing components required to perform the innovative Method of the present invention within a single firewall device.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Method and Technique for Automated Collection, Analysis, and Distribution of Network Security Threat Information.

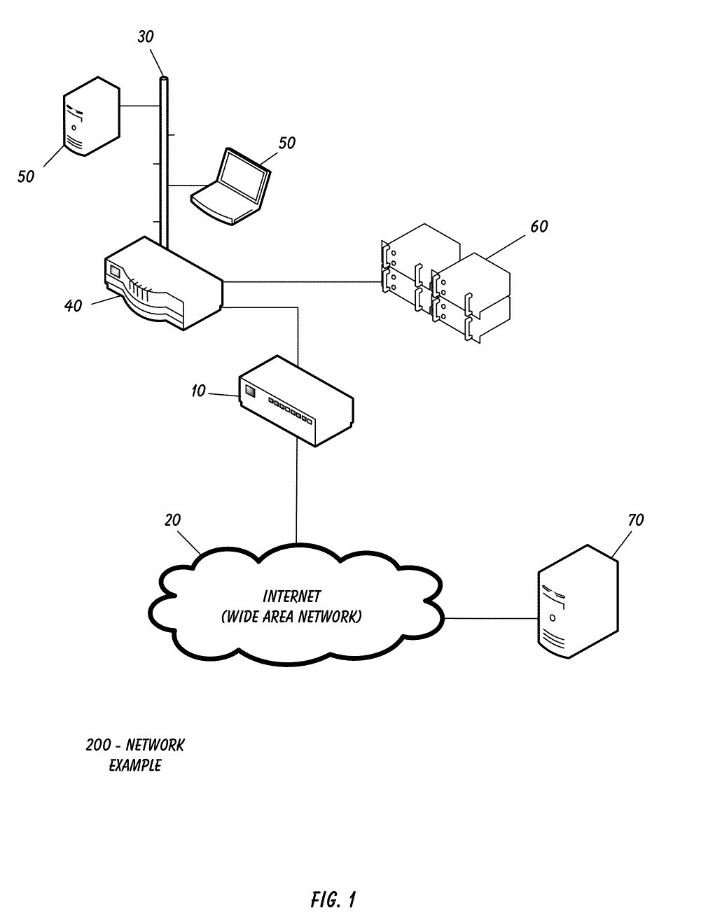

The present invention can best be understood by initial consideration of FIG. 1.¹ FIG. 1 is a network diagram with a preferred embodiment of firewall device 10 performing the Method of the present invention, over one network location. The firewall device 10 receives Ethernet traffic comprising internet protocol (IP) packets originating from internet protocol (IP) addresses. The firewall 10 then filters all inbound network packets, rejecting those that are from IP addresses that match those contained in a built-in threat blocklist, and permitting those from IP address that do not match those on the block list. In this way, the devices behind the firewall device 10, which can be a single computer or entire network, are protected from malicious traffic that does not originate from safe providers. ¹ As used throughout this disclosure, element numbers enclosed in square brackets [ ] indicates that the referenced element is not shown in the instant drawing figure, but rather is displayed elsewhere in another drawing figure.

This same filtering also occurs in the opposite direction by dropping IP packets that are sent to blocked IP addresses (from a computer 50) located in the local area computer network. The blocklist is supplied by a central server that exists external to the protected network 30, which can be run by an organization of some commercial or Governmental authority. Periodic update requests are automatically issued to the server 70 and updates to the blocklist are received in response. The central blocklist server 70 can service a vast number of firewalls 10.

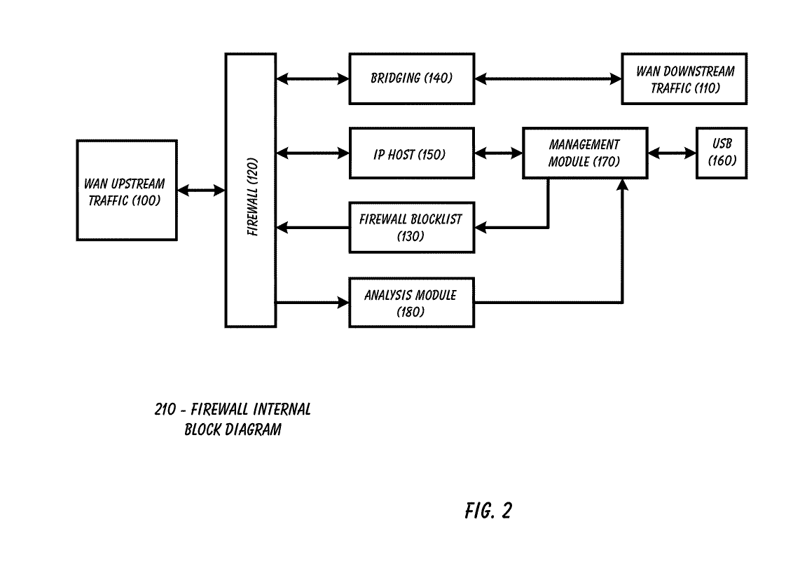

FIG. 2 is an internal block diagram of the computational blocks of a typical firewall device 10 that performs the Method of the present invention. All functions of the invention are done automatically with no human intervention. WAN Upstream traffic is filtered through the block list 130 (also known herein as a “black list”). For packets that are allowed through, the device 10 acts as a transparent bridge 140, with IP packets received in the input being relayed on the output (downstream traffic 110 or upstream traffic 100). Packets that have been rejected are either dropped immediately or routed to an isolated, monitored system 60. The device 10 and current blocklist can be programmed via a physical universal serial bus (USB) connection or, more commonly, via IP host module 150 that configures the firewall 10 as a separate device on the network.

Most of the modern firewalls are software-based, and as such they are designed to only handle a small number of blacklist entries. A large blacklist would cause them to run out of CPU performance and start dropping IP packets. The proposed device does not operate on a general purpose CPU; it is capable of handling large blacklists, and it will not impair the performance or quality of the line.

The approach of this Invention handles this function with the separate firewall device.

The device 10 additionally collects data and statistics about the internet traffic seen at the device 10 and transmits reports to the central server 70. Future block lists will be created based on these reports. This is an important intelligence gathering function that will allow the central server 70 to evaluate the activity of threats across the global infrastructure of installed devices 10. The central server 70 can then automatically record what threats are more active, and respond by elevating the priorities of the threat monitoring to the firewall devices 10 in the field. This essentially creates a WAN-level closed-loop system.

With the method and system of the present Invention, no human interaction is required in the analysis of WAN-level traffic, collection of statistics, or redistribution of threat data.

### DIAGRAM REFERENCE NUMERALS

10 Firewall Device
20 Internet
30 Protected Network
40 Subnet Router
50 Protected Devices
60 “Honeypot” Servers
70 Central Blocklist Server
100 WAN Upstream Traffic
110 WAN Downstream Traffic
120 Firewall IP Address Filter
130 Firewall Blocklist
140 Transparent Bridge
150 IP Host
160 USB Interface
170 Management Module
180 Analysis Module
200 Example Network Topology
210 Firewall Internal Block Diagram
300 Invention

### Operation

The operation of invention is described in this section. A firewall device 10 is installed on the edge of a single typical user network 200 (LAN). The invention covers this type of installation in many thousands of sites. The device 10 has two Ethernet interfaces: an upstream interface and a downstream interface. The first interface handles WAN Upstream Traffic 100 facing the broader Internet 20 (i.e. external). The second interface handles WAN Downstream Traffic 110 facing the user's protected network 30 (i.e. internal). This protected network can contain additional IP routers 40 as well as various networked computing devices 50. Both upstream and downstream packets are inspected and filtered by a firewall 120. Using its built-in blocklist 130, the firewall 10 filters all packets for target or source addresses that match the list (that again is provided by the commercial or Governmental authority). Those packets containing addresses that are not on the block list are passed to the proper interface through a transparent bridge 140. Packets that contain addresses on the blocklist are dropped or routed to an isolated, controlled “honeypot” system 60. Such honeypot systems 60 can be used to misdirect or otherwise perform counter attack operations on the incoming threat activity.

Periodically (and automatically), the central server 70 sends blocklist updates to each firewall device 10. This automatic update generally occurs over Ethernet by targeting the IP address which is managed by the IP Host 150 on the device.

There is also a hardware USB interface 160 that can be used to update the device 10. Both the IP Host and the USB interface send updates to the Management Module 170, which handles updating of the Firewall Blocklist 140. The Management Module 170 also collects traffic statistics and other data from the Analysis Module 180 which is in turn sent back to the central server 70 for the closed loop WAN-level analysis and control.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. An automated distributed wide area computer network firewall system, comprising:
a central threat server computing device in communication with a wide area computer network;
a first firewall device in communication with said wide area computer network on an external side and a local area computer network on an internal side;
a second firewall device in communication with said wide area computer network on an external side and a local area computer network on an internal side; and
wherein each said firewall device comprises:
an internal IP Host subsystem in communication with said central threat server computing device via said wide area computer network to receive threat reports from said central threat server computing device;
an internal Management subsystem in communication with said internal IP Host subsystem, said Management subsystem configured to create a blocklist responsive to said threat reports; and
an internal Firewall subsystem configured to redirect data packages emanating from said wide area computer network and destined for said local area computer network, said redirecting responsive to said blocklist.

2. The system of claim 1, wherein:
each said firewall device further comprises an internal Analysis subsystem in communication with said Firewall subsystem and said Management subsystem, said Analysis subsystem configured to record data related to said redirected data packages and periodically generate activity reports, said activity reports transmitted to said Management subsystem; and
said Management subsystem is further configured to transmit said activity reports to said central threat server computing device.

3. The system of claim 2, wherein said central threat server computing device is configured to generate a said threat report responsive to an activity report received from said first firewall device and to further transmit said threat report to said second firewall device.

4. The system of claim 3, wherein said central threat server computing device is further configured to generate a said threat report responsive to an activity report received from said second firewall device and to further transmit said threat report to said first firewall device.

5. The system of claim 4, wherein said firewall devices further comprise an internal Isolation server computing device configured to store some or all of said redirected data packages.

6. The system of claim 5, wherein said internal Firewall systems of said firewall devices is further configured to redirect data packages emanating from said local area computer network and destined for said wide area computer network, said redirecting responsive to said blocklist.

7. The system of claim 6, wherein said Management modules of said firewall devices are further configured to receive said threat reports from a direct connection to a data storage device.

8. A method for redirecting data packages transmitted between a wide area computer network and a local area computer network, comprising the steps of:
installing a firewall device between said wide area computer network and said local area computer network, said firewall device configured to redirect data packages arriving at said firewall device addressed for a location within said local area computer network, said redirecting responsive to an internal blocklist;
installing a central server computing device in communication with said wide area computing network;
sending a threat report from said central server computing device to said firewall device; and
revising said internal blocklist within said firewall device responsive to said received threat report.

9. The method of claim 8, further comprising the steps of:
generating an activity report within said firewall device responsive to said redirectings;
transmitting said activity report from said firewall device to said central server computing device; and
sending another said threat report responsive to said received activity report.

10. The method of claim 9, wherein said redirecting comprises redirecting said arriving packages to an internal Isolation server computing device in communication with said local area computer network, said Isolation server computing configured to store some or all of said redirected data packages.

11. The method of claim 10, further comprising the step of installing a second said firewall device between said wide area computer network and a second said local area computer network, said firewall device configured to redirect data packages arriving at said second firewall device addressed for a location within said second local area computer network, said redirecting responsive to a second said internal blocklist;
sending a threat report from said central server computing device to said second firewall device; and
revising said second internal blocklist within said second firewall device responsive to said received threat report.

12. The method of claim 11, wherein said revising of said second internal blocklist is responsive to an activity report transmitted by said first firewall device.

13. A distributed firewall system, comprising:
a central threat server computing device in communication with a wide area computer network;
a plurality of firewall devices, with each said firewall device in communication with said wide area computer network on an external side and a local area computer network on an internal side; and
wherein each said firewall device comprises:
an internal IP Host subsystem in communication with said central threat server computing device via said wide area computer network to receive threat reports from said central threat server computing device;
an internal Management subsystem in communication with said internal IP Host subsystem, said Management subsystem configured to create a blocklist responsive to said threat reports; and
an internal Firewall subsystem configured to redirect data packages emanating from said wide area computer network and destined for a computing device in communication with said local area computer network, said redirecting responsive to said blocklist.

14. The system of claim 13, wherein:
each said firewall device further comprises an internal Analysis subsystem in communication with said Firewall subsystem and said Management subsystem, said Analysis subsystem configured to record data related to said redirected data packages and periodically generate activity reports, said activity reports transmitted to said Management subsystem; and
said Management subsystem is further configured to transmit said activity reports to said central threat server computing device.

15. The system of claim 14, wherein said central threat server computing device is configured to generate a said threat report responsive to an activity report received from said first firewall device and to further transmit said threat report to said second firewall device.

16. The system of claim 15, wherein said central threat server computing device is further configured to generate a said threat report responsive to an activity report received from one said firewall device and to further transmit said threat report to another said firewall device.

17. The system of claim 16, wherein said firewall devices further comprise an internal Isolation server computing device configured to store some or all of said redirected data packages.

18. The system of claim 17, wherein said internal Firewall systems of said firewall devices is further configured to redirect data packages emanating from said local area computer network and destined for said wide area computer network, said redirecting responsive to said blocklist.

19. The system of claim 18, wherein said Management modules of said firewall devices are further configured to receive said threat reports from a direct connection to a data storage device.

20. The system of claim 13, wherein said firewall devices further comprise an internal Isolation server computing device configured to store some or all of said redirected data packages.
